(19) United States
(12) Patent Application Publication
(10) Pub. No.: US 2001/0018931 A1
(43) Pub. Date: Sep. 6, 2001

(54) Storage tank for viscous oil containing easily polymerizable compounds

(76) Inventors: Yuichi Ijiri, Himeji-shi (JP); Yukihiro Matsumoto, Kobe-shi (JP); Sei Nakahara, Himeji-shi (JP); Fumio Munechika, Himeji-shi (JP)

Correspondence Address: WENDEROTH, LIND & PONACK, L.L.P., 2033 K STREET N. W., SUITE 800, WASHINGTON, DC, 20006-1021, US

(21) Appl. No.: 09/788,598

(22) Filed: Feb. 21, 2001

(30) Foreign Application Priority Data
Feb. 21, 2000 (JP) 2000-43411 (PAT.)

(51) Int. Cl. G05D 7/00

(52) U.S. Cl. 137/558; 366/194

(57) ABSTRACT

This invention relates to a storage tank for a viscous oil containing easily polymerizable compounds. A storage tank of the present invention for strong viscous oil containing easily polymerizable compounds, comprising a bottom plate 12, a side wall 13, a draw-off pipe 3 and a inlet pipe 2. The bottom plate 12 slopes downward toward the draw-off pipe 3 and an angle of downward inclination of the bottom plate 12 is gradient at least 1/200. It becomes possible by the present inventive storage tank to effectively prevent the polymerization of the easily polymerizable compounds contained in the waste oil within the storage tank and the clogging of a pipe is suppressed considerably.

### BACKGROUND OF THE INVENTION

1. Field of the Invention

This invention relates to a tank for storing a viscous oil containing easily polymerizable compounds. In particular, the invention pertains to a storage tank for bottom liquid which is obtained by distilling a crude liquid to obtain an easily polymerizable compound such as (meth)acrylic acid and/or liquid containing thereof.

2. Description of the Prior Art

Conventionally, Distillation (e.g. distillation tower) have been utilized for producing an easily polymerizable compound such as (meth)acrylic acid and/or (meth)acrylic ester from a crude liquid. The distillation is an operation in which a crude liquid composed of two or more liquids in a mixed manner each having a different boiling point is heated for vaporization. During the distillation, a gas (or vapor) mainly composed of a component having a lower boiling point is condensed and taken out of the distillation tower. And also a liquid mainly composed of a component having a high boiling point is stored at the bottom of the distillation tower. The liquid stored at the bottom may be redistilled for recovering active principles of the liquid and thus condensed liquid, which is also stored at the bottom has high viscosity and is removed continuously or non-continuously form the distillation tower as a waste oil and feeds to a tank for storing thereof. The waste oil stored in the storage tank may be transferred to a waste oil processing unit such as a combustion equipment and the waste oil may be disposed by burning treatment or by other treatment.

Since the waste oil has high viscosity, the waste oil in the storage tank is stored at relatively high temperatures to lower its viscosity. Even though storing the waste oil at the high temperatures is effective to lower its viscosity, the high temperature storage facilitates the polymerization of easily polymerizable compounds contained in the waste oil. In this case, a stabilizer such as a polymerization inhibitor is added to the waste oil to prevent polymerization of the compounds. Even though the stabilizer suppresses the polymerization of the easily polymerizable compounds, the stabilizer tends to be precipitated easily at high temperatures, because of these properties of the waste oil, the polymerization inevitably would occur in the storage tank, the polymerization products cause the problems of clogging a pipe which connects the storage tank and a waste oil processing unit. And also the polymerization products cause the clogging of a pipe of an attached unit.

The polymerization product which is adhered to a inside wall of the pipe hamper the ability of transferring the waste oil to the waste oil processing unit and need to be removed manually or chemically at regular intervals. These removing operations lower the waste oil treatment efficiency and even lower the distillation efficiency.

### SUMMARY OF THE INVENTION

A storage tank for strong viscous oil containing easily polymerizable compounds, comprising a bottom plate 12, a side wall 13, a draw-off pipe 3 and a inlet pipe 2 The bottom plate 12 slopes downward toward the draw-off pipe 3 and an angle of downward inclination of the bottom plate 12 is gradient at least 1/200.

### BRIEF DESCRIPTION OF THE DRAWINGS

FIG. 1 is a schematic diagram of a storage tank in accordance with one embodiment of the invention.

FIG. 2 is a schematic diagram of a installation of a diaphragm liquid level meter in accordance with one embodiment of the invention.

FIG. 3 is a schematic diagram of a storage tank in accordance with one embodiment of the invention.

FIG. 4 is a schematic diagram of a storage tank in accordance with one embodiment of the invention.

### DETAILED DESCRIPTION OF THE PREFERRED EMBODIMENTS OF THE INVENTION

As a result of thorough investigation, the inventors of this invention found out that providing a storage tank with a bottom plate having downward slope toward a waste oil draw-off pipe which is connected to a side wall of the storage tank and/or installing the waste oil draw-off pipe at the lowest part of the bottom plate can prevent the waste oil sequestration in the storage tank remarkably. Accordingly the present invention can reduce the amount of waste oil that remains without flowing in the tank and effectively draw off the waste oil thorough the draw-off pipe. With the prompt draw off of the waste oil from the storage tank, it becomes possible to effectively prevent the polymerization of the easily polymerizable compounds contained in the waste oil within the tank and the clogging of a pipe is suppressed considerably.

According to the present invention, “waste oil” herein means a oil containing easily polymerized compounds and also a oil having high viscosity. The “high viscosity” and “strong viscosity” means a viscosity having 0.001 to 1 Pa·s (also 1 to 1000 cp) at its treated temperature (normally, the temperature is in the range of 20 to 200° C.). The “easily polymerizable compounds” herein means a compound which is liable to be polymerized during its treatment at Its treatment temperature. To be more specific, (meth)acrylic acid and its ester such as methyl ester, ethyl ester, n-propyl ester, isopropyl ester, n-butyl ester, isobutyl ester, 2-hydroxy ethyl ester and N,N-dimethyl amino ethyl ester can be exemplified as easily polymerizable compounds.

Accordingly the waste oil to be treated in the present invention may be a liquid consisting of at least one selected from the easily polymerizable compounds or may be a liquid containing at least one selected from the easily polymerizable compounds mentioned above. And also the waste oil may be a bottom liquid (also referred to as “bottoms”) which is obtained by distilling a liquid containing easily polymerizable compounds for refining or condensing the easily polymerizable compounds.

The waste oil used in the present invention may be the bottoms obtained form the following acrylic acid production process. Acrylic acid is can be recovered by contacting an acrylic acid containing gas obtained through gas-phase catalytic oxidation of propylene and/or acrolein with water to trap the acrylic acid in the form of its aqueous solution, distilling said aqueous acrylic acid solution in an azeotropic separation column in the presence of an azeotropic solvent, and purifying the crude acrylic acid obtained from the bottom part of said azeotropic separation column in high boiling impurities separation column, said improvement comprising recovering acrylic acid from the bottom liquid of said high boiling impurities separation column (i.e. the high boiling impurities containing acrylic acid dimer, acrylic acid and maleic acid).

Even more specifically, in the above acrylic acid production process, introducing said high boiling impurities containing acrylic acid dimer, acrylic acid and maleic acid into an acrylic acid recovery column composed of a distillation column equipped with a thin film vaporizer, wherein conducting distillation under conditions of 10 to 100 mmHg and at the bottom temperature of the column of 60 to 120° C., distilling acrylic acid off from the column top and recovering the same. And introducing bottoms from said thin film vaporizer into pyrolyzing tank, whereat decomposing acrylic acid dimer in said bottoms at temperatures of 120 to 220° C. and thereafter, recalculating at least a part of bottoms of said pyrolyzing tank into said thin film vaporizer and/or the distillation column, at a ratio of 1 to 20 times in volume to the high boiling impurities containing acrylic acid dimer, acrylic acid and maleic acid. The present invention is preferably applicable to the condensed bottoms obtained above process. Details of the method for recovering acrylic acid described in EP0887334A1 is incorporated by reference.

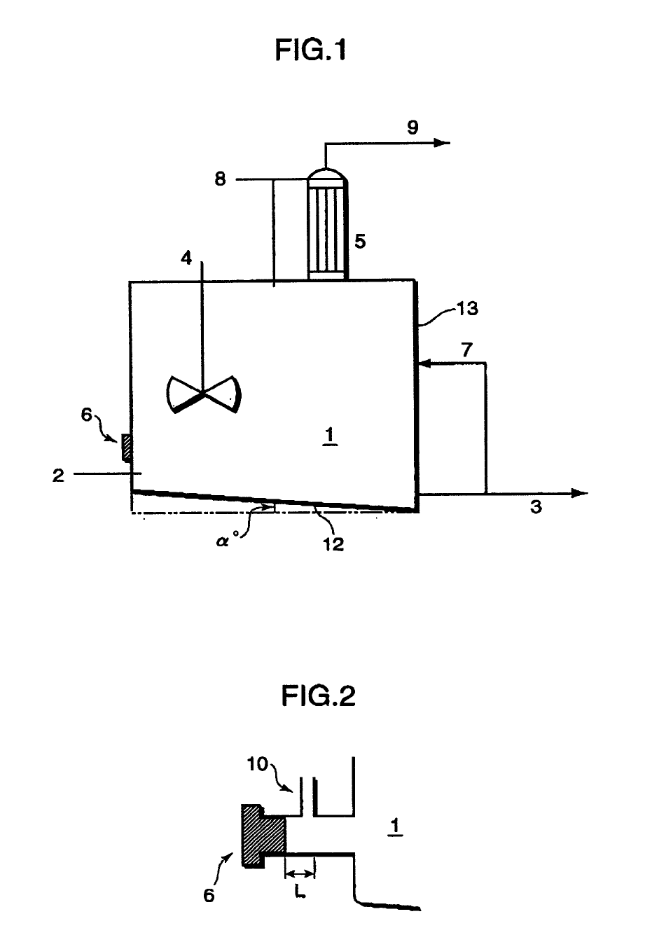

The present invention will be further illustrated with reference to FIG. 1, which is schematic diagram of one embodiment of a storage tank for use in the invention. It should be noted that the apparatus of FIG. 1 to 4 is just an example of an apparatus usable in the method of the present invention, and the present invention does not necessarily use this apparatus.

The feature of the present invention resides in employing a bottom plate 12 of the storage tank 1, the bottom plate 12 slopes downward toward waste oil draw-off pipe 3 as depicted in FIG. 1. An angle a of downward inclination of the bottom plate 12 is gradient at least 1/200, more preferably be equal to or larger than 1/100 and even more preferably be equal to or larger than 1/50. It is highly possible to accumulate the polymerized products at the bottom of the storage tank 1 and which resulted in clogging the draw-off pipe 3 if the angle a is smaller than 1/200.

The upper limit of the angle a is not specifically limited but preferably 1/1 and most preferably 1/1.5 for lowering the tank manufacturing cost.

The method of forming such a gradient α in the bottom plate 12 is not specifically limited. As an example, a concrete foundation may be prepared to have a desired gradient α prior to installing a storage tank 1. The gradient α can be formed by installing a bottom plate 12 to have such a predetermined gradient α.

If the tank bottom 12 slopes in this way, it becomes possible to effectively draw off the stored waste oil and reduce the amount of the waste oil that remains without flowing in the storage tank 1.

The waste oil draw-off pipe 3 is preferably equipped at the lowest part of the side wall 13. The lower the draw-off pipe 3 is installed, the more the waste oil can be drawn off from the storage tank.

According to the present invention, an agitator 4 is preferably installed in the storage tank 1 for stirring the waste oil in the storage tank 1. Any types of the agitator which can stirring the waste oil in the storage tank 1 can be employed as the agitator 4. The agitator 4 may be an agitator having a puddle wheel, a propeller or turbine blades. The number of the agitator 4 installed in the storage tank 1 is not specifically limited. The agitator 4 may be used alone or in combination with other type. The plurality of the agitators may be installed so as to form a multi-stage type (e.g. the agitators may be installed so as not to exist in the same horizontal line with each other).

The agitator 4 improves to homogenize the composition of the waste oil in the storage tank 1 which resulted in suppressing the polymerization of the easily polymerizable compounds effectively and also suppressing the precipitation of the stabilizer. The agitator 4 is effective -to reduce the amount of the waste oil that remains without flowing in the tank.

A condenser 5 for condensing liquid from vapor is preferably installed to the storage tank 1. The waste oil at high temperature which is fed to the storage tank is liable to be vaporized. From the environmental viewpoint, it is unfavorable to discharge the vapor from the storage tank to atmosphere without treating the vapor.

The vapor introduced to the condenser 5 is condensed into liquid and residual gas may be processed by conventionally known treatment before discharging to atmosphere. The condensed liquid may be fed back to the storage tank 1 or may be fed to other treatment process unit. Any types of the condenser can be used and the position of the condenser 5 equipped to the storage tank 1 is not specifically limited. The condenser 5 is preferably mounted on the storage tank 1 as shown in FIG. 1 and a shell tube type heat exchanger, a in line vapor-liquid condensation, is preferably employed as the condenser. When a vent line of the condenser is large or the amount of the vapor is small, a double pipe condenser is preferably employed by lengthening the vent line and attaching a jacket cover to the line.

A liquid-level meter for measuring the waste oil level in the storage tank 1 is preferably installed to the storage tank 1. A diaphragm type liquid level meter is preferably employed for detecting the waste oil level. The diaphragm type liquid level meter has advantages in that the diaphragm type liquid level meter has a simple structure and it also has smaller contact area with the waste oil compared with the other known liquid-level meter. The smaller contact area enables to reduce the amount of the waste oil hold-up part in the tank and which resulted in suppressing the polymerization in the tank effectively.

The diaphragm type liquid level meter is preferably attached to the side wall 13 of the storage tank 1 so as to the surface of the diaphragm type liquid level meter is preferably flush mount with the inner surface of the side wall 13 as shown in FIG. 1. Also as shown in FIG. 2, the diaphragm type liquid level meter 6 can be attached to the Storage tank with connecting one end of T-shaped connector 10 (horizontal line). One end of the connector 10 is attached with the diaphragm type liquid level meter 6, the other end, which is co-linear to the diaphragm type liquid level meter 6 attached end, to connected to the storage tank 1 and the lest end, which is connected to the co-linear pipe from the crossing direction, is connected with the waste oil inlet pipe 2. The shorter the length L (i.e. length between the liquid level meter 6 and the waste oil inlet pipe 2 connected point), the more the polymerization of the easily polymerizable compounds in the waste oil existed in this part L can be suppressed.

A waste oil return pipe 7 for returning the part of the waste oil taken from the waste oil draw-off pipe 3 to the storage tank 1 is preferably installed according to the present invention.

A part of the waste oil which is withdrawn from the storage tank 1 through the draw-off pipe 3 is preferably returned to the storage tank 1 through the waste oil return pipe 7 by a circulating pump (not shown). It becomes possible to make the composition of the waste oil in the storage tank to homogenize and to prevent its polymerization.

The polymerization of the easily polymerizable compounds in the waste oil is effectively suppressed when the waste oil maintains its uniform composition in the storage tank 1. It should be noted that the waste oil return pipe 7 is preferably equipped with heat insulating material such as insulation jacket for preventing heat loss and for suppressing the generation of the precipitate in the waste oil return pipe 7. A heat exchanger (not shown) can be installed at any position of the waste oil return pipe 7 for regulating the temperature of the waste oil.

An oxygen containing gas supply means for supplying oxygen containing gas to the storage tank 1 and/or to the condenser 5 is preferably employed according to the present invention. The oxygen containing gas can be supplied to the storage tank 1 and/or to the condenser 5 through an oxygen containing gas supply pipe 8 (other end of the pipe 8 is connected to the oxygen containing gas supply means (not shown)). The oxygen containing gas can also be supplied to the storage tank 1 by admixing with the waste oil to be supplied. The oxygen containing gas can effectively suppress the polymerization of the easily polymerizable compounds. The supply amount of the oxygen containing gas is not specifically limited as long as the enough amount for suppressing the polymerization is supplied. More specifically, it is recommended to add the oxygen containing gas at a rate of 0.1% (oxygen concentration is preferably 10% or less) by tank volume per hour with respect to the total tank volume.

A temperature controlling means for maintaining the waste oil temperature in the storage tank 1 at desired temperature is preferably employed according to the present invention. The polymerization of the easily polymerizable compounds and the precipitation of the stabilizer in the storage tank is effectively suppressed by regulating the temperature of the liquid stored in the storage tank 1. Any types of the temperature controlling means can be employed according to the present invention. As the temperature controlling means, heating jacket or coil can be installed around the outside wall of the storage tank 1 or a heat exchanger can be installed at any position of the waste oil return pipe 7 which can heat or cool the waste oil therethrough.

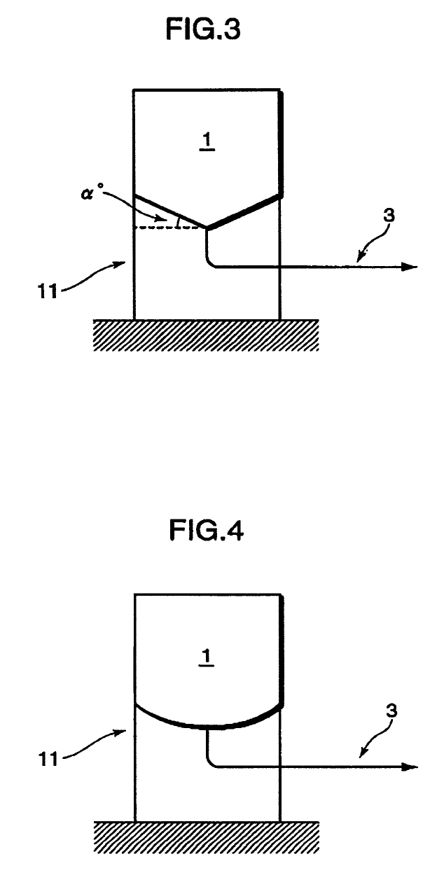

FIG. 3 and FIG. 4 are schematic side view of the storage tank in accordance with one embodiment of the invention. In FIG. 3, a storage tank 1 has circular cone type bottom plate and in FIG. 4, a storage tank 1 has curved type bottom plate. In both cases, the storage tank 1 may be supported by struts 11. The waste oil supply pipe 2 (not shown in FIG. 3 and in FIG. 4) can be connected the storage tank 1 at any desired position of the tank and also the waste oil return pipe 7, and other devices such as condenser 5 and liquid level meter 6 and agitator 4 can be equipped at any desired position of the storage tank 1 if necessary (also not shown in FIG. 3 and in FIG. 4) as mentioned in FIG. 1. The waste oil draw-off pipe 3 is preferably equipped at the lowest part of the bottom plate 12 as shown in FIG. 3 and in FIG. 4. It becomes possible to draw off the stored waste oil and reduce the amount of the waste oil that remains without flowing in the tank 1 which lead to prevent the polymerization effectively. When utilize the storage tank 1 such as shown in FIG. 3, the bottom plate 2 is preferably meets the angle α as mentioned above to obtain effective draw off of the stored waste oil and reduce the amount of the waste oil that remains without flowing in the storage tank 1.

As long as the waste oil draw-off pipe 3 is connected to the lowest part of the bottom plate, a level lower than the level of the other plate part, the position of the lowest part of the bottom plate is not specifically limited in FIG. 3 and in FIG. 4. The lowest part may be positioned at the center of the bottom plate or may be positioned at any place of the bottom plate.

The storage tank 1 of the present invention may be of any convenient shape which is commonly used for bottoms. Generally, tanks having a circular or square shape in horizontal cross section are used. The shape of a roof at the top of the storage tank 1 is not particularly limited either. For example, the storage tank 1 may be a cone-roof, dome-roof or flat-roof tank.

The shape of the bottom plate 12 is not limited to any specific shape. The bottom plate is preferably flat plate for easy installation.

Furthermore, ancillary devices preferably used in the invention, such as the heat exchanger (not shown) and circulating pump (not shown) are not limited to specific types or constructions.

The position where the waste oil supply pipe 2, waste oil draw-off pipe 3 and waste oil return pipe 7 are connected to the storage tank 1 is not particularly limited. For example, the waste oil supply pipe 2 may be connected to the side wall or roof of the storage tank 1. The liquid return pipe 7 may be connected to the side wall or roof of the storage tank 1. Ends of these pipes 2, 3 and 7 may or may not extend into the interior of the storage tank 1. The position of the waste oil supply pipe 2 and waste oil return pipe 7 in relation to the waste oil draw-off pipe 3 is not specifically limited to any specific position. It is preferable to connect the waste oil supply line 2 Can reduce the possibility of formation of waste oil holdup parts in the storage tank effectively. When assuming that the waste oil supply pipe 2 and the waste oil draw-off pipe 3 are located at the same height, feed opening of the waste oil supply pipe 2 is preferably positioned on the extended line joining the inhalation opening of the waste oil draw-off pipe 3 and the central point of a horizontal cross section of the storage tank 1.

The invention will be further illustrated in detail with reference to several inventive examples and comparative examples below which are not intended to limit the scope of the invention.

### EXAMPLE 1

A waste oil used in the example 1 was obtained from the acrylic acid production process. The high boiling impurities containing acrylic acid dimer, acrylic acid and maleic acid was introduce into an acrylic acid recovery column composed of a distillation column equipped with a thin-film evaporating device, wherein conducting distillation under conditions of 10 to 100 mmHg and at the bottom temperature of the column of 60 to 120° C., distilling acrylic acid off from the column top and recovering the same. And introducing bottoms from said thin film vaporizer into pyrolyzing tank, whereat decomposing acrylic acid dimer in said bottoms at temperatures of 120 to 220° C. and thereafter, recalculating at least a part of bottoms of said pyrolyzing tank into said thin film vaporizer and/or the distillation column, at a ratio of 1 to 20 times in volume to the high boiling impurities containing acrylic acid dimer, acrylic acid and maleic acid.

The condensed bottoms obtained above process was fed to the storage tank 1 such as shown in FIG. 1 through waste oil supply pipe 2.

Flat plate was used as a bottom plate of the storage tank 1. A propeller type agitator 4 was used as an agitator for mixing the waste oil in the storage tank 1 and the agitator 4 was operated continuously at constant speed. The storage tank 1 was equipped with a diaphragm type liquid level meter 6 for measuring the waste oil level in the storage tank 1. A part of the waste oil extracted thorough the waste oil draw-off pipe 3 was circulated to the storage tank 1 through the waste oil return 7. A vertical multi-pipe heat exchanger 5 was mounted on the storage tank for condensing the vaporized waste oil. A Gas was passed through tube-side and the cooling water was passed through shell-side of the heat exchanger.

Storage tank capacity: 5 m³

Gradient α: 1/30 (2° downwardly inclined to the waste oil draw-off pipe 3)

Heat transfer area of the vertical multi-pipe heat exchanger: 2 m²

Temperature at the entrance of the shell-side: 32° C.

Flow rate at the shell-side: 2 m³/h

Composition of the waste oil: acrylic acid (5 mass%), acrylic acid dimer (30 mass%), maleic acid (5 mass%), impurities (60 mass%)

Viscosity of the waste oil: 0.04 Pa·s (40 cp) at 100° C.

Temperature of the waste oil in the storage tank: 120° C.

Feed rate of the waste oil: 2000 kg/h

circulating rate of the waste oil through the waste oil return pipe 7: 2500 kg/h

Draw off rate of the waste oil from the storage tank 1 through the-waste oil draw-off pipe 3: 200 kg/h

After one month operation, no polymerized products nor precipitates was generated at the bottom of the storage tank 1 and no clogging of the pipes 3 and 7 was occurred.

### COMPARATIVE EXAMPLE 1

The same operation was conducted as Example 1 except that the gradient α was set at zero (no slope was provided)

After one month operation, the polymerized product was accumulated at the bottom of the storage tank 1 and the pipes 3 and 7 was clogged by the polymerized products.

### EXAMPLE 2

The same operation was conducted as Example 1 except that the draw off rate of the waste oil from the storage tank 1 through the waste oil draw-off pipe 3 was set at 300 kg/h.

After one month operation, no polymerized products nor precipitates was generated at the bottom of the storage tank 1 and no clogging of the pipes 3 and 7 was occurred.

### COMPARATIVE EXAMPLE 2

The same operation was conducted as Example 2 except that the gradient α was set at zero (no slope was provided)

After one month operation, the polymerized product was accumulated at the bottom of the storage tank 1 and the pipes 3 and 7 was clogged by the polymerized products.

### EXAMPLE 3

The waste oil obtained from the same process as in Example 1 was fed to the storage tank 1 having circular cone type bottom plate shown in FIG. 3. A propeller type agitator was used as an agitator 4 for mixing the waste oil in the storage tank 1 and the agitator 4 was operated continuously. The tank has A diaphragm type liquid level meter was equipped for measuring the waste oil level in the storage tank. A part of the waste oil extracted thorough the extract pipe 7 is circulated to the storage tank through pipe 7. A vertical multi-pipe heat exchanger was mounted on the storage tank for condensing the vaporized waste oil. Gas was passed through tube-aide and the cooling water was passed through shell-side of the heat exchanger.

Storage tank capacity: 10 m³

Gradient α: 1/4 (15° inclined to the pipe)

Composition of the waste oil: butyl acrylate (5 mass%), acrylic acid (5 mass%), impurities (90 mass%)

Viscosity of the waste oil: 0.005 Pa·s (5 cp) at 100° C.

Temperature of the waste oil in the storage tank: 160° C.

Feed rate of the waste oil: 2000 kg/h

Circulating rate of the waste oil through pipe 7: 1500 kg/h

Draw off rate of the waste oil from the storage tank 1 through the waste oil draw-off pipe 3: 300 kg/h

After one month operation, no polymerized product and precipitate was generated in the storage tank and no clogging of the pipe was occurred.

### COMPARATIVE EXAMPLE 3

The same operation was conducted as Example 3 except that the gradient α was set at zero (no slope was provided).

After one month operation, the polymerized product was accumulated at the bottom of the storage tank and the pipe was clogged by the polymerized products.

### EXAMPLE 4

The same operation was conducted as Example 1 except that the draw off rate of the waste oil from the storage tank 1 through the waste oil draw-off pipe 3 was set at 500 kg/h.

After one month operation, no polymerized products nor precipitates was generated at the bottom of the storage tank 1 and no clogging of the pipes 3 and 7 was occurred.

### COMPARATIVE EXAMPLE 4

The same operation was conducted as Example 4 except that the gradient α was set at zero (no slope was provided)

After one month operation, the polymerized product was accumulated at the bottom of the storage tank and the pipe was clogged by the polymerized products.

This application is based on Japanese patent application No.2000-043411 filed on Feb. 21, 2000, whose priority is claimed under Paris convention, thus the contents thereof is incorporated by reference.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. A storage tank for viscous oil containing easily polymerizable compounds, comprising:
a bottom plate 12:
a side wall 13;
a draw-off pipe 3; and
a inlet pipe 2;
said bottom plate 12 slopes downward toward the draw-off pipe 3;
an angle of downward inclination of the bottom plate 12 is gradient at least 1/200.

2. The storage tank according to claim 1, wherein the draw-off pipe 3 is connected at the lowest part of the bottom plate 12.

3. The storage tank according to claim 1, wherein the viscous oil containing easily polymerizable compounds is bottoms which is obtained by distilling a liquid containing (meth)acrylic acid and ester thereof.

4. The storage tank according to claim 1, wherein the storage tank is equipped with at least one selected form the group consisting of an agitator, a condenser, a diaphragm liquid level meter or a temperature controlling device.
